(19) United States
(12) Patent Application Publication
(10) Pub. No.: US 2014/0029275 A1
(43) Pub. Date: Jan. 30, 2014

(54) LED MOUNTING ASSEMBLY

(71) Applicant: Minggang XIONG, Yugao City (CN)

(72) Inventor: Minggang XIONG, Yugao City (CN)

(73) Assignee: Ningbo Yofun Heating Appliance Co., Ltd., Yuyao City (CN)

(21) Appl. No.: 13/940,926

(22) Filed: Jul. 12, 2013

(30) Foreign Application Priority Data
Jul. 24, 2012 (CN) 201220360567.6

(51) Int. Cl. F21V 23/04

(52) U.S. Cl. CPC F21V 23/04
USPC 362/394

(57) ABSTRACT

The present patent application discloses a LED mounting assembly. The LED mounting assembly include buttons, LEDs, button bases, light touch switches and PCB substrate; the buttons are formed as hollow and transparent bodies, two pins of each LED are welded to the PCB substrate, each of light touch switches is arranged between the two pins of LED and attached to the PCB substrate, one electrode of the light touch switch is electrically connected to one of the pins of LED, the button bases are superposed over the light touch switches, lower end surfaces of the buttons contact with upper end surfaces of the button bases, and the LEDs are accommodated in the inner space of the buttons, respectively.

### CROSS REFERENCE TO RELATED PATENT APPLICATION

The present patent application claims benefit of Chinese patent application No. 201220360567.6 filed on Jul. 24, 2012, the entire contents of which is incorporated by reference.

### FIELD OF THE PATENT APPLICATION

The present patent application generally relates to technical field of a multi-functional domestic electrical appliance, and more specifically to a LED mounting assembly.

### BACKGROUND

At present, most of multi-functional domestic electrical appliances in the market use LEDs to indicate ON and OFF of their function, for example, toaster. For the mounting of LEDs in the similar products, the LEDs are usually mounted on both sides of button, so as to achieve an indicative effect. However, this structural relation has following defects or disadvantages. First, during the assembly of the products, when arranging functional button switches, operator's fingers are inclined to contact the LED tube, causing the LED tube to be tilted. This will lead to position offset and angle which cause misplace, so that LEDs are not able to achieve a proper indicative effect. Meanwhile, pins of the LED are easy to break, and in that case, the LED of button are not capable of being in the state of ON, so as to lose display or indicative effect. Second, two LEDs are usually mounted in the similar products. Consequentially, they would occupy some space in the products, so that it increases the difficulty of mounting during the assembly of the products. Meanwhile, the costs of manufacture are increased and thus profit and benefit of manufacturer is reduced.

### SUMMARY

The patent application provides a LED mounting assembly which ensures that the position and the angle of the LED tubes not to offset and be in a proper place during the assembly of the product.

The present patent application provides a LED mounting assembly. The LED mounting assembly include buttons, LEDs, button bases, light touch switches and PCB; the buttons are formed as hollow and transparent bodies, two pins of each LED are welded to the PCB, each of light touch switches is arranged between the two pins of LED and attached to the PCB, one electrode of the light touch switch is electrically connected to one of the pins of LED, the button bases are superposed over the light touch switches, lower end surfaces of the buttons contact with upper end surfaces of the button bases, and the LEDs are accommodated in the inner space of the buttons, respectively.

The present patent application properly addresses following problem: during the assembly of the products, operator's fingers are inclined to contact the LED tube, causing the LED tube to be tilted. Therefore, the patent application ensures that the position and the angle of the LED tubes could not offset and be in a proper place, so that a good indicative effect of LEDs is achieved. Meanwhile, a LED is saved. Further, functional buttons and LED housing are formed as a whole, so that the functional buttons have both functions of button and LED housing, which greatly reduces the manufacturing cost.

In one embodiment, slots are arranged on both sides of the button bases. The arrangement of the slots is mainly used to position two pins of LED in place so as not to swing or be tilted. Therefore, the slots more desirably ensure that the position and the angle of the LED tubes not to offset and the LED tubes to be in a proper place.

In another embodiment, at least one cylindrical foot is provided at the bottom of each button base, and guide holes into which corresponding cylindrical feet may slide are arranged on the light touch switches and the PCB. This arrangement makes buttons, button bases and light tough switches properly aligned and not to swing, which ensures a stability of the button bases.

### DESCRIPTION OF FIGURES

FIG. 1 shows the structure of a LED mounting assembly according to the present patent application; and

FIG. 2 is an exploded view of the LED mounting assembly according to the present patent application.

In figures, reference numeral 1 indicates buttons; reference numeral 2 indicates LEDs; reference numeral 21 indicates pins; reference numeral 3 indicates button bases; reference numeral 31 indicates slots; reference numeral 32 indicates cylindrical feet; reference numeral 4 indicates light touch switches; reference numeral 41 indicates guide holes; and reference numeral 5 indicates PCB.

### DETAILED DESCRIPTION

Reference will now be made in detail to a preferred embodiment of the LED mounting assembly disclosed in the present patent application, examples of which are also provided in the following description. Exemplary embodiments of the method disclosed in the present patent application are described in detail, although it will be apparent to those skilled in the relevant art that some features that are not particularly important to an understanding of the method may not be shown for the sake of clarity.

Furthermore, it should be understood that the LED mounting assembly disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

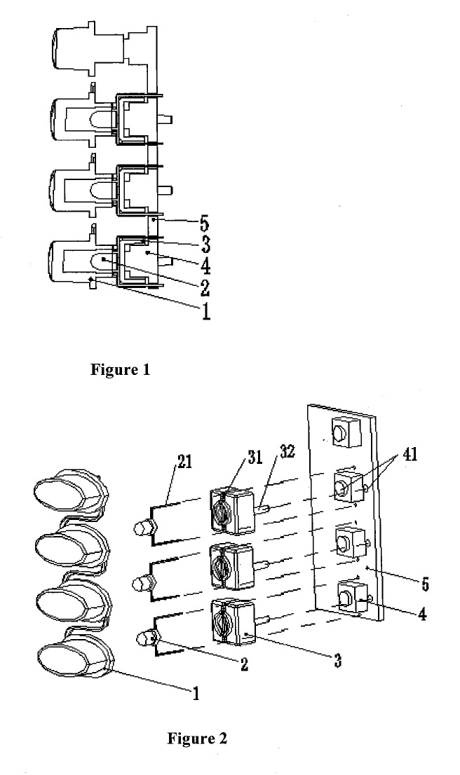

As show in FIGS. 1 and 2, a LED mounting assembly according to the present patent application includes buttons 1, LEDs 2, button bases 3, light touch switches 4 and PCB 5. The buttons 1 are formed as hollow and transparent bodies. Two pins 21 of each LED 2 are welded to the PCB 5. Each of light touch switches 4 is arranged between the two pins 21 of LED 2 and attached to the PCB 5. One electrode of the light touch switch 4 is electrically connected to one of the pins 21 of LED 2. The button bases 3 are superposed over the light touch switches 4. Lower end surfaces of the buttons 1 contact with upper end surfaces of the button bases 3. The LEDs 2 are accommodated in the inner space of the buttons 1, respectively. Also, slots 31 are arranged on both sides of the button bases 3. At least one cylindrical foot 32 (two cylindrical feet 32 in this embodiment) is provided at the bottom of each button base 3. Guiding holes 41 into which corresponding cylindrical feet 32 may slide are arranged on the light touch switches 4 and the PCB 5.

Above description is only directed to the preferred embodiment of the present patent application. It will be apparent to ordinary person skilled in the art that various improvements and modifications can be made to the patent application without departing from the technical principle of the patent application. Those improvements and modifications should also be regarded as protection scope of the present patent application.

We claim:

1. A LED mounting assembly comprising: buttons (1), LEDs (2), button bases (3), light touch switches (4) and PCB substrate (5); wherein the buttons (1) are formed as hollow and transparent bodies, two pins (21) of each LED (2) are welded to the PCB substrate (5), each of light touch switches (4) is arranged between the two pins (21) of LED (2) and attached to the PCB substrate (5), one electrode of the light touch switch (4) is electrically connected to one of the pins (21) of LED (2), the button bases (3) are superposed over the light touch switches (4), lower end surfaces of the buttons (1) contact with upper end surfaces of the button bases (3), and the LEDs (2) are accommodated in the inner space of the buttons (1), respectively; wherein slots (31) are arranged on both sides of the button bases (3); and wherein at least one cylindrical foot (32) is provided at the bottom of each button base (3), and guide holes (41) into which corresponding cylindrical feet (32) slide are arranged on the light touch switches (4) and the PCB substrate (5).

2. A LED mounting assembly comprising: buttons (1), LEDs (2), button bases (3), light touch switches (4) and PCB substrate (5); wherein the buttons (1) are formed as hollow and transparent bodies, two pins (21) of each LED (2) are welded to the PCB substrate (5), each of light touch switches (4) is arranged between the two pins (21) of LED (2) and attached to the PCB substrate (5), one electrode of the light touch switch (4) is electrically connected to one of the pins (21) of LED (2), the button bases (3) are superposed over the light touch switches (4), lower end surfaces of the buttons (1) contact with upper end surfaces of the button bases (3), and the LEDs (2) are accommodated in the inner space of the buttons (1), respectively.

3. The LED mounting assembly according to claim 2, wherein slots (31) are arranged on both sides of the button bases (3).

4. The LED mounting assembly according to claim 2, wherein at least one cylindrical foot (32) is provided at the bottom of each button base (3), and guide holes (41) into which corresponding cylindrical feet (32) slide are arranged on the light touch switches (4) and the PCB substrate (5).

5. The LED mounting assembly according to claim 3, wherein at least one cylindrical foot (32) is provided at the bottom of each button base (3), and guide holes (41) into which corresponding cylindrical feet (32) slide are arranged on the light touch switches (4) and the PCB substrate (5).
